(19) United States
(12) Patent Application Publication
(10) Pub. No.: US 2013/0064250 A1
(43) Pub. Date: Mar. 14, 2013

(54) REMOTELY ACCESSING AND CONTROLLING USER EQUIPMENT IN A PRIVATE NETWORK

(71) Applicants: Byung-Jae KIM, Daejeon (KR); Geun-Young Kim, Daejeon (KR); Sang-Jo Kim, Daejeon (KR); Jeong-Gyun Ahn, Daejeon (KR); Byung-Gu Lee, Daejeon (KR)

(72) Inventors: Byung-Jae KIM, Daejeon (KR); Geun-Young Kim, Daejeon (KR); Sang-Jo Kim, Daejeon (KR); Jeong-Gyun Ahn, Daejeon (KR); Byung-Gu Lee, Daejeon (KR)

(73) Assignee: KT CORPORATION

(21) Appl. No.: 13/608,352

(22) Filed: Sep. 10, 2012

(30) Foreign Application Priority Data
Sep. 9, 2011 (KR) 10-2011-0091788

(51) Int. Cl. H04L 12/12

(52) U.S. Cl. 370/401

(57) ABSTRACT

Described embodiments provide a method for enabling a remote terminal outside a private network to remotely access and control at least one user equipment inside the private network by a remote access control device in the private network. A gateway device of the private network may be requested to set up first port forwarding enabling the remote terminal to remotely access the remote access control device, receiving a remote access request message from the remote terminal through the first port forwarding. After setting up the first port forwarding setup, the gateway device may be required to set up second port forwarding enabling the remote terminal to remotely access selected user equipment indicated in the received remote access request message in response to the remote access request message.

### CROSS REFERENCE TO PRIOR APPLICATIONS

The present application claims priority under 35 U.S.C. §119 to Korean Patent Application No. 10-2011-0091788 (filed on Sep. 9, 2011), which is hereby incorporated by reference in its entirety.

### FIELD OF THE INVENTION

The present invention relates to communication and, in particular, to enabling user equipment outside a private network to remotely access and control at least one user equipment inside the private network.

### BACKGROUND OF THE INVENTION

A home network may be a private network that allocates a private IP address to related device for communication. The home network may be referred to as a home area network (HAN) or a residential local area network. In the home network, electronic devices may be connected to each other as one system through a wired/wireless network and communicate with each other in various ways. Particularly, a universal plug and play (UPnP) protocol has been employed for communication in the home network. The home network may include various types of electronic devices such as home appliances, computers, and portable devices.

In the home network, each device may notify the presence of itself to others by multicasting a simple service discovery protocol (SSDP) message to the other devices. A device receiving the SSDP message may discover other devices in the home network and recognize a type of device based on information recorded in the received SSDP message. For example, a device may access a uniform resource locator recorded in a LOCATION field of a SSDP message and obtain detail information of an UPnP device therefrom. Typically, the LOCATION field may include a URL of an extensible markup language (XML) document having description information about a related device. The description information may include information on a manufacturer, a model number, and a presentation URL. Using such the description information, a user might access a presentation URL through a web browser and use a user interface for a desired device. When a home network is formed using an IP sharing device such as a router or a gateway device, a presentation URL may include information on a private IP address of a related device. However, a device outside home network cannot remotely access or control a device inside the home network only with the presentation URL.

In order to enable a device outside the home network to remotely access and to remotely control devices inside the home network, a user may be required to perform typical complicated processes. For example, the user may be required to set up port forwarding in a gateway device in the home network. After port forwarding, the user may be also required to obtain a dynamic public IP address allocated to the gateway device.

### SUMMARY OF THE INVENTION

This summery is provided to introduce a selection of concepts in a simplified form that are further described below in the detailed description with reference to the drawings. This summary is not intended to identify key features or essential features of the claimed subject matter, nor is not intended to limit the scope of the claimed subject matter. Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, a remote terminal outside a private network may be enabled to remotely access and control user equipments inside the private network through a simple procedure of setting up port forwarding.

In accordance with another aspect of the present invention, first port forwarding may be set up to enable a remote terminal to remotely access a remote access control device and second pot forwarding may be set up to enable the remote terminal to remotely access and control user equipments inside the private network.

In accordance with still another aspect of the present invention, first port forwarding may be set up based on a public IP address and a port number allocated to a gateway device and a private IP address and a pot number allocated to a remote access control device. Second port forwarding may be set up based on a public IP address and a port number allocated to a gateway device and a private IP address and a port number allocated to a selected user equipment to remotely access and control.

In accordance with embodiments of the present invention, a method may be provided for enabling a remote terminal outside a private network to remotely access and control at least one user equipment inside the private network by a remote access control device in the private network. The method may include requesting a gateway device of the private network to set up first port forwarding enabling the remote terminal to remotely access the remote access control device, receiving a remote access request message from the remote terminal through the first port forwarding, and requesting the gateway device to set up second port forwarding enabling the remote terminal to remotely access selected at least one user equipment indicated in the received remote access request message in response to the remote access request message.

The requesting a gateway device of the private network to set up first port forwarding may include requesting the gateway device to set up the first port forwarding based on a public IP address and a port number allocated to the gateway device and a first private IP address and a first port number allocated to the remote access control device. The gateway device may set up the first port forwarding to translate the public IP address and the port number allocated to the gateway device to the first private IP address and the first port number allocated to the remote access control device.

The method may further include receiving a request for information on the at least one user equipment inside the private network from the remote terminal through the first port forwarding and providing the requested information to the remote terminal.

The method may further include receiving simple service discovery protocol (SSDP) messages multicasted from the user equipments inside the private network, obtaining information regarding the at least one user equipment based on the received SSDP messages, and storing the obtained information in a memory. In this case, the remote access control device may transmit the stored information to the remote terminal in response to the request for information.

The remote terminal may select at least one user equipment inside the private network to remotely access and to remotely control based on the provided information and create the remote access request message based on the selected at least one user equipment.

The requesting the gateway device to set up second port forwarding may include requesting the gateway device to set up the second port forwarding based on a public IP address and a port number allocated to the gateway device and a second private IP address and a second port number allocated to the selected at least one user equipment.

The gateway device may set up the second port forwarding by translating the public IP address and the port number allocated to the gateway device to the second private IP address and the second port number allocated to the selected user equipment.

In accordance with another embodiment of the present invention, a remote access control device may be provided for enabling a remote terminal outside a private network to remotely access and control at least one user equipment inside the private network. The remote access control device may include a receiver, a transmitter, a first port forwarding setup request unit, and a second port forwarding request unit. The receiver may be configured to receive a multicast message from each user equipment inside the private network, to receive a request for information regarding the at least one user equipment from the remote terminal, and to receive a remote access request message from the remote terminal. The first port forwarding setup request unit may be configured to request a gateway device to set up first port forwarding in order to enable the remote terminal to remotely access the remote access control device. The second port forwarding setup request unit may be configured to request the gateway device to set up second port forwarding in order to enable the remote terminal to remotely access and control selected user equipment inside the private network in response to the received remote access request message. The transmitter may be configured to transmit the information regarding the at least one user equipment to the remote terminal in response to the request for information.

The first port forwarding setup request unit may be configured to request the gateway device to set up the first port forwarding based on a public IP address and a port number allocated to the gateway device and a first private IP address and a first port number allocated to the remote access control device.

The gateway device may set up the first port forwarding to translate the public IP address and the port number allocated to the gateway device to the first private IP address and the first port number allocated to the remote access control device.

The receiver may be configured to receive simple service discovery protocol (SSDP) messages multicasted from the at least one user equipment as the multicast message, to obtain the information on each user equipment based on the received SSDP messages, and to store the obtained information in a memory. The transmitter may transmit the stored information to the remote terminal in response to the request for information.

The remote terminal may select at least one user equipment inside the private network to remotely access and control based on the provided information and to create the remote access request message based on the selected user equipment.

The second pot forwarding setup request unit may be configured to request the gateway device to set up the second port forwarding based on a public IP address and a port number allocated to the gateway device and a second private IP address and a second port number allocated to the selected user equipment. The gateway device may set up the second port forwarding to translate the public IP address and the port number allocated to the gateway device to the second private IP address and the second port number allocated to the selected user equipment.

In accordance with still another embodiment of the present invention, a gateway device may be provided for enabling a remote terminal outside a private network to remotely access and control at least one user equipment inside the private network, The gateway device may be configured to set up first port forwarding to forward packets from the remote terminal to a remote access control device in response to a first port forwarding setup request from the remote access control device and to set up second port forwarding to forward packets from the remote terminal to a selected user equipment in response to a second port forwarding setup request from the remote access control device.

The gateway device may be configured to set up the first port forwarding to translate a public IP address and a port number allocated to the gateway device to a first private IP address and a first port number allocated to the remote access control device.

The gateway device may be configured to set up the second port forwarding to translate a public IP address and a port number allocated to the gateway device to a second private IP address and a second pot number allocated to a selected user equipment in the private network.

The remote access control device may be configured to receive a request for information regarding the at least one user equipment inside the private network from the remote terminal through the first port forwarding and to provide the requested information to the remote terminal through the first port forwarding. In this case, the remote terminal may be configured to receive the requested information through the first port forwarding, to select one of the at least one user equipment in the private network to remotely access and control based on the received information, and to transmit a remote access request message to the remote access control device through the first port forwarding. The remote access control device may be configured to receive the remote access request message from the remote terminal and to transmit the second port forwarding setup request to the gateway device to set up the second port forwarding in response to the remote access request message.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 shows a home network connected to a public network in accordance with embodiments of the present invention;

FIG. 2 shows a remote access control device in accordance with embodiment of the present invention;

FIG. 3 is a diagram for describing port forwarding set up to enable a remote terminal for remotely accessing and controlling user equipments inside a private network in accordance with embodiments of the present invention; and

FIG. 4 shows a method for enabling user equipment outside a home network to access at least one user equipment inside the home network in accordance with embodiments of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

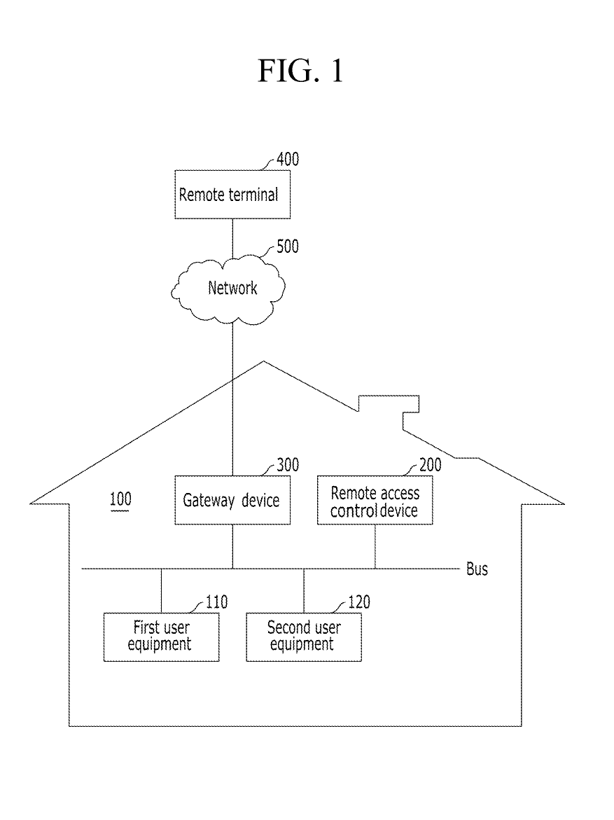

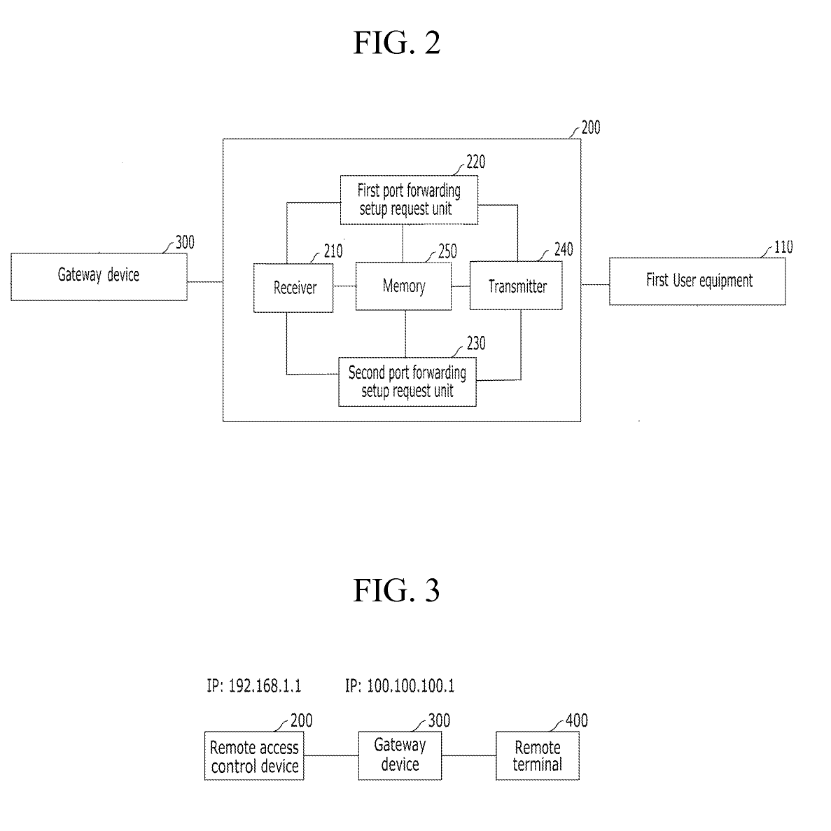

In accordance with embodiments of the present invention, user equipment outside a private network might remotely access and remotely control at least one user equipment inside the private network. In order to enable such a remote access and control, a remote access control device may request a gateway device to set up first port forwarding to enable the user equipment outside the private network to access the remote access control device and then request the gateway device to set up second port forwarding to enable the user equipment outside the private network to remotely access and control the user equipment inside the private network in accordance with embodiments of the present invention. Hereinafter, the remote access control device in accordance with embodiments of the present invention will be described with reference to FIG. 1 and FIG. 2. For convenience and ease of understanding, a private network will be described as a home network but the present invention is not limited thereto. The private network may be a local area network using a private IP address. For example, the private network may include a residential local area network, an office local area network, and an enterprise local area network as well as the home network.

FIG. 1 shows a home network connected to a public network in accordance with embodiments of the present invention.

Referring to FIG. 1, home network 100 in accordance with embodiments of the present invention may be a residential local area network, formed by gateway device 300 and providing communication environment to devices capable of communication and certain functions, such as a computer, a printer, and a portable device. For example, home network 100 may include at least one of first and second user equipments 110 and 120, remote access device 200, and gateway device 300. Such home network 100 may be formed by gateway device 300 and connected to outside network 500 through gateway device 300. Remote terminal 400 may remotely access and control at least one user equipment 110 and 120 inside home network 100 through gateway device 300 of home network 100 in accordance with embodiments of the present invention. For convenience and ease of understanding, remote terminal 400 may be described with a different term but remote terminal 400 and first and second user equipment 110 and 120 may be implemented with the same types of electronic devices. Particularly, remote terminal 400 and first and second user equipment 110 and 120 might be of the same type of electronic devices but located at different places, especially outside home network 100 and inside home network 100.

First and second user equipment 110 and 120 may be electronic devices capable of communication to each other and having a processing power for performing certain tasks. Particularly, first and second user equipment 110 and 120 may be universal plug and play (UPnP) devices in home network 100. UPnP may be a set of networking protocols that permits networked devices to seamlessly discover each other's presence on the same network and establish functional network services for data sharing, communications, and entertainment. Furthermore, first user equipment 110 and second user equipment 120 may be connected through a bus of home network 100. The bus of home network 100 may be a wireless communication link or a wired communication link. First and second user equipments 110 and 120 may include a server, a personal computer (PC), a workstation, a desktop computer, a laptop computer, a printer, a scanner, a television set, a home appliance, a tablet PC, a handheld device, a cellular phone, a personal digital assistant (PDA), and a smart phone. Particularly, first and second user equipment 110 and 120 may include a personal communication system (PCS) terminal, a global system for mobile communication (GSM) terminal, a personal digital cellular (PDC) terminal, a personal handy phone system (PHS) terminal, a personal digital assistant (PDA), an international mobile telecommunication (IMT)-2000 terminal, a code division multiple access (CDMA)-200 terminal, a wideband code division multiple access (WCDMA) terminal, a wireless broadband internet (WiBro) terminal, and a smart phone. The present invention, however, is not limited thereto. First and second user equipments 110 and 120 may be various types of electronic device capable of communication and having a processing power for performing certain tasks.

In accordance with embodiments of the present invention, first and second user equipments 110 and 120 may be allocated with a private IP address and a port number from gateway device 300 for communication. First and second user equipment 110 and 120 may multicast a simple service discovery protocol (SSDP) message in home network 100. Through the SSDP message, remote access device 200 may obtain information on user equipment 110 and 120 based on a LOCATION field of the SSID message.

Remote terminal 400 may be located at outside home network 100 and attempt to remotely access and control one of user equipment 110 and 120 inside home network 100 through network 500. As described, remote terminal 400 may be described with a different term but be the same type of electronic device as user equipments 110 and 120. Remote terminal 400 may be any electronic device having a computation power and capable of communicating with other devices through a communication network. For example, remoter terminal 400 may be various types of computers installed with a web browser, such as a server, a workstation, a desktop computer, and a laptop computer. Furthermore, remote terminal 400 may be portable user equipment such as, but not limited to, a PCS terminal, a GSM terminal, a PDC terminal, a PHS terminal, a PDA, an IMT-2000 terminal, a CDMA-2000 terminal, a WCDMA terminal, a WiBro terminal, and a smart phone.

In accordance with embodiments of the present invention, remote terminal 400 may be enabled to access remote access control device 200 after gateway device 300 sets up first port forwarding. Such first port forwarding may be set up in response to a request of access remote access control device 200. After the first port forwarding setup, remote terminal 400 may receive information on first and second user equipment 110 and 120 inside home network 100 from remote access control device 200. Based on the received information, remote terminal 400 may select target user equipment to remotely control and transmit a remote access request message to remote access control device 200 in accordance with embodiments of the present invention. In response to the remote access request message, gateway device 300 may set up second port forwarding to enable remote terminal 400 to remotely access and control the target user equipment inside home network 100 in accordance with embodiments of the present invention.

Gateway device 300 may be a networking device having multiple functions for forming and managing home network 100 and connecting user equipments 110 and 120 inside home network 100 to an external network such as Internet and other wide area network (WAN). For example, gateway device 300 may provide devices inside home network 100 with a path to the Internet or other wide area network (WAN). Furthermore, gateway device 300 may provide devices outside home network 100 with a path to devices inside home network 100. In order to provide such multiple functions, gateway device 300 may include a routing function and a network address translation (NAT) function. The routing function may forward data packets between computer networks. The NAT function may modify IP address information in an IP packet header. Particularly, gateway device 300 may be an IP sharing device having an UPnP Internet Gateway function in accordance with embodiments of the present invention. For example, gateway device 300 may be allocated with one public IP address from a communication service provider for a WAN interface and share the one public IP address with user equipments 110 and 120 inside home network 100 through the NAT function in accordance with embodiments of the present invention.

Particularly, gateway device 300 may set up first port forwarding to enable remote terminal 400 to access remote access control device 200 in response to a request from remote access control device 200 in accordance with embodiments of the present invention. Furthermore, gateway device 300 may set up second port forwarding to enable remote terminal 400 to remotely access and control one of first and second user equipment 110 and 120 in response to a request from remote terminal 400 in accordance with embodiments of the present invention. That is, gateway device 300 may set up port forwarding to enable devices outside a private network to access devices inside the private network. Such port forwarding may translate an address and a port number of a packet to a new destination. Through setting up the port forwarding, gateway device 300 may connect a private IP address and a port number allocated to a certain device inside home network 100 to a public IP address and a port number allocated to gateway device 300 in accordance with embodiments of the present invention. For example, when a device outside home network 100 attempts to access through the public IP address and the port number allocated to gateway device 300 after gateway device 300 set up port forwarding with a private IP address and a port number of a certain device inside home network 100, gateway device 300 may transfer related packets to the certain device. Accordingly, after setting up such port forwarding, a device outside home network 100 might access a certain device inside home network 100.

Remote access control device 200 may control port forwarding of gateway device 300 in accordance with embodiments of the present invention. Remote access control device 200 may be described as an independent device as shown in FIG. 2, but the present invention is not limited thereto. Remote access control device 200 may be implemented inside gateway device 300 in accordance with another embodiment of the present invention.

For example, remote access control device 200 may request gateway device 300 to setup first port forwarding and receive a response message from gateway device 300 after gateway device 300 sets up the first port forwarding. The first port forwarding setup may enable remote terminal 400 to access remote access control device 200.

After the first port forwarding setup, remote access control device 200 may transmit information on regarding first and second user equipment 110 and 120 inside home network 100 to remote terminal 400 in accordance with embodiments of the present invention. Remote access control device 200 may collect such information by receiving a simple service discovery protocol (SSDP) message from each of first and second user equipment 110 and 120 in home network 100. Remote access device 200 may obtain a description document based on a LOCATION field of the SSID message and store the obtained description document. The description document may include information regarding first and second user equipment 110 and 120 inside home network 100. Based on the information regarding first and second user equipment 110 and 120, remote terminal 400 may select one of first and second user equipment 110 and 120 in order to remotely access and control. After selection, remote terminal 400 may transmit a remote access request message to remote access control device 200.

In response to such remote access request message, remote access control device 200 may request gateway device 300 to set up second port forwarding in accordance with embodiments of the present invention. After setting up the second port forwarding, remote access control device 200 may transmit a response message to remote terminal 400. Through the second port forwarding, remote terminal 400 may remotely access and control at least one of first and second user equipment 110 and 120 inside home network 100 in accordance with embodiments of the present invention.

As described, remote access device 200 may enable remote terminal 400 to remotely access and control one of first and second user equipment 110 and 120 inside home network 100 by requesting gateway device 300 to set up the first and second port forwarding in accordance with embodiments of the present invention. Particularly, the second port forwarding may enable remote terminal 400 to remotely access and control one selected from first and second user equipment 110 and 120 inside home network 100 in accordance with embodiments of the present invention.

Typically, remote terminal 400 outside home network 100 and first and second user equipment 110 and 120 inside home network 100 may be required to frequently, constantly, and/or consistently transmit various types of state and control messages to each other and required to receive response messages thereof through gateway device 300. Due to the resulting large amount of messages and responses, this process may be unnecessarily complicated and create increase in process load. In accordance with embodiments of the present invention, remote terminal 400 may be enabled to remotely access and control at least one of first and second user equipment 110 and 120 simply through setting up second port forwarding. Hereinafter, remote access control device 200 in accordance with embodiments of the present invention will be described with reference to FIG. 2.

FIG. 2 shows a remote access control device in accordance with embodiment of the present invention.

Referring to FIG. 2, remote access control device 200 may be connected to first user equipment 110 and gateway device 300 in the home network. Furthermore, remote access control device 200 may be connected to remote terminal 400 outside the home network through gateway device 300. Remote access control device 200 is described as being connected to first user equipment 110 in FIG. 2, but the present invention is not limited thereto. Remote access control device 200 may be connected to second user equipment 120. As described, remote access control device 200 may enable remote terminal 400 outside home network 100 to remotely access and control at least one of first and second user equipment 110 and 120 by requesting gateway device 300 to set up first and second port forwarding in accordance with embodiments of the present invention.

As shown in FIG. 2, remote access control device 200 may include receiver 210, first port forwarding setup request unit 220, second port forwarding setup request unit 230, transmitter 240, and memory 250.

Receiver 210 may receive a SSDP message from one of more of first and second user equipment 110 and 120, collect information on first and second user equipment 110 and 120 based on the received SSDP message, and store the collected information in memory 250. Such information may be transmitted to remote terminal 400 through transmitter 240 in response to a related request. Furthermore, receiver 210 may receive a remote access request message through the first port forwarding from remote terminal 400 to remotely access and control at least one user equipment 110 and 120 in home network 100.

First port forwarding setup request unit 220 may request gateway device 300 to set up first port forwarding to enable remote terminal 400 to access remote access control device 200 in accordance with embodiments of the present invention. In response to the request, gateway device 300 may set up first pot forwarding to connect a private IP address and a port number allocated to remote access control device 200 with a public IP address and a port number allocated to gateway device 300. That is, gateway device 300 may set up to translate a public IP address and a port number allocated to gateway device 300 to a private IP address and a port number allocated to remote access control device 200. Through the first port forwarding, gateway device 300 may forward packets from remote terminal 400 to remote access control device 200 and forward packets from remote access control device 200 to remote terminal 400.

Second port forwarding setup request unit 230 may request gateway device 300 to set up second port forwarding in response to the received remote access request message from remote terminal 400 in accordance with embodiments of the present invention. The second port forwarding may enable remote terminal 400 to remotely access and control the selected one of first and second user equipment 110 and 120. That is, gateway device 300 may set up the second port forwarding to translate a private IP address and a pot number allocated to the selected user equipment to a public IP address and a port number allocated to gateway device 300. When remote access control device 200 requests the second port forwarding setup to gateway device 300, gateway device 300 may set up the second port forwarding for enabling remote terminal 400 to access the selected user equipment 110. The result of the second port forwarding may be transferred to remote terminal 400 through the first port forwarding. That is, gateway device 300 may set up to translate a public IP address and a port number allocated to gateway device 300 to a private IP address and a port number allocated to one of first and second user equipment 110 and 120, which is selected by remote terminal 400. Through the second port forwarding, gateway device 300 may forward packets from remote terminal 400 to the selected one of first and second user equipment 110 and 120 and forward packets from the selected one to remote terminal 400.

Transmitter 240 may transmit information on user equipments 110 and 120 inside home network 100 to remote terminal 400 after gateway 300 set up the first port forwarding. Such information may be obtained and stored in memory 250. Particularly, when remote terminal 400 wants to remotely access and control one of first and second user equipment 110 and 120 inside home network 100, remote terminal 400 may send a request for information on the corresponding one of first and second user equipment 110 and 120 to remote access control device 200. In response to such request, transmitter 240 may transmit the information stored in memory 250.

As described, remote access control device 200 may enable remote terminal 400 to remotely access and control the selected one of first and second user equipment 110 and 120 inside home network 100 through the first port forwarding and the second port forwarding in accordance with embodiments of the present invention. Such port forwarding will be described in detail with reference to FIG. 3.

FIG. 3 is a diagram for describing port forwarding set up to enable a remote terminal to remotely access and control user equipment inside a private network in accordance with embodiments of the present invention.

In accordance with embodiments of the present invention, remote access control device 200 may be allocated with a private IP address from gateway device 300 included in home network 100. Such a private IP address may be ‘192. 168. 1. 1’ as shown in FIG. 3. Gateway device 300 may be allocated with a public IP address from a communication service provider. The public IP address may be ‘100. 100. 100. 1’ as shown in FIG. 3.

Gateway device 300 may set up the first port forwarding to enable remote terminal 400 to access remote access control device 200. When remote terminal 400 attempts to access home network 100 with a public IP address allocated with gateway device 300 and an external port number setup at the first port forwarding, gateway device 300 may translate the public IP address to the private IP address of remote access control device 200 according to the first port forwarding. That is, gateway device 300 may enable remote terminal 400 to directly access remote access control device 200 by translating the public IP address to the private IP address of remote access control device 200 based on the first port forwarding.

For example, when remote terminal 400 attempts to access home network 100 with the public IP address ‘100. 100. 100. 1’ of gateway device 300, gateway device 300 may translate the public IP address ‘100. 100. 100. 1’ to the private IP address ‘192. 168. 1. 1’ of remote access control device 200 according to the first port forwarding in accordance with embodiments of the present invention. Particularly, a packet from remote terminal 400 may have a header with the public IP address of ‘100. 100. 100. 1.’ Gateway unit 300 may change such IP address information to the private IP address of ‘192. 168. 1. 1.’, but the present invention is not limited thereto. Such translation may be realized in various methods.

As described, remote access control device 200 in accordance with embodiments of the present invention may enable remote terminal 400 outside the home network to remotely access and control at least one of first and second user equipment 110 and 120 inside home network 100. Hereinafter, such operation of remote access control device 200 in accordance with embodiments of the present invention will be described hereinafter. For convenience and ease of understanding, a home network will be representatively described as a private network, but the present invention is not limited thereto. As well as the home network, the private network may include a residential local area network, an office local area network, and an enterprise local area network.

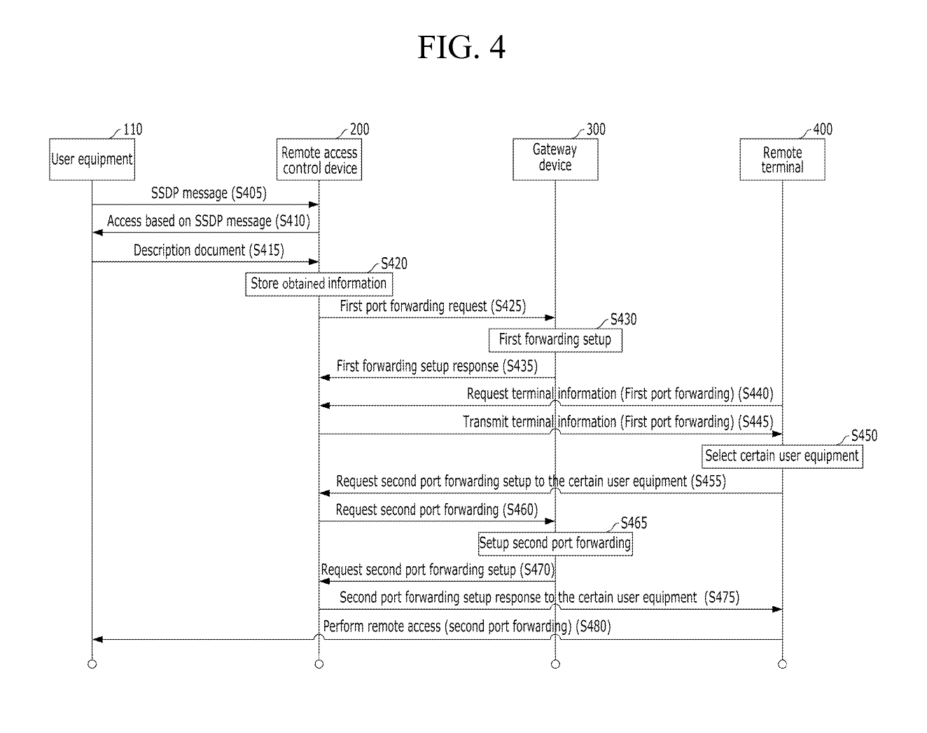

FIG. 4 shows a method for enabling user equipment outside a home network to access at least one of one or more user equipment inside the home network in accordance with embodiments of the present invention.

Referring to FIG. 4, a SSDP message may be multicasted in a home network at step S405. For example, user equipment 110 may multicast a SSDP message to others inside the same home network, such as user equipment 120 and remote access control device 300. That is, user equipment 110 may advertise the presence of itself to others inside home network 100 by multicasting the SSDP message. Based on the SSDP message, others including user equipment 120 and remote access control device 200 may obtain information on user equipment 110. The SSDP message may include information for accessing a description XML document of user equipment 110. Particularly, the SSDP message may include a LOCATION field. The LOCATION field may include information on a uniform resource locator (URL) for accessing the description XML document of user equipment 110.

At step S410, remote access control device 200 may access user equipment 110 using the information for accessing the description XML document of user equipment 110, for example, the information included in the LOCATION field of the SSDP message. That is, remote access control device 200 may access a URL of the description XML document based on the SSDP message.

At step S415, remote access control device 200 may obtain the description XML document from user equipment 110. At step S420, remote access control device 200 may store the information of user equipment 110 based on the received description XML document at step S420.

At step S425, remote access control device 200 may request gateway device 300 to set up first port forwarding. For example, the first port forwarding may enable remote terminal 400 outside home network 100 to remotely access remote access control device 200 inside home network 100.

At step S430, gateway device 300 may set up the first port forwarding in response to the request of remote access control device 200. For example, gateway device 300 may set up the first port forwarding based on a private IP address and a port number of remote access control device 200 and the public IP address and an external port number of gateway device 300. That is, gateway device 300 may enable remote terminal 400 to direct access remote access control device 200 through the first port forwarding.

At step S435, gateway device 300 may respond to remote access control device 200 after setting up the first port forwarding. For example, in response to the first port forwarding setup request, gateway device 300 may transmit a response message to remote access control device 200.

At step S440, remote terminal 400 may access remote access control device 200 through the first port forwarding and request information on at least one user equipment inside the home network. At step S445, remote access control device 200 may transmit the requested information of each user equipment to remote terminal 400 in response to the request.

At step S450, remote terminal 400 may select one of first and second user equipment 110 and 120 inside home network 100 based on the information of first and second user equipment 110 and 120 inside home network 100.

At step S455, remote terminal 400 may transmit a remote access request message to remote access control device 200 through the first port forwarding. The remote access request message is a request message to access the selected user equipment among the various user equipment inside the home network.

At step S460, remote access control device 200 may request gateway device 300 to set up second port forwarding based on the remote access request message. That is, remote access control device 200 may request gateway device 300 to set up second port forwarding to enable remote terminal 400 to remotely access and to remotely control the selected user equipment based on the received remote access request message.

At step S465, gateway device 300 may receive the second port forwarding setup request message from remote access control device 200 and set up the second port forwarding. At step S470, gateway device 300 may transmit a response message to remote access control device 200 in response to the second port forwarding setup request message. For example, gateway device 300 may set up the second port forwarding based on a private IP address of the selected user equipment and a port number for controlling the selected user equipment, a public IP address of gateway device 300 and an external port number for controlling the selected user equipment. The external port number may be assigned when the second pot forwarding is requested.

At step S475, remote access control device 200 may transmit a result of setting up the second port forwarding to remote terminal 400 through the first port forwarding. At step S480, remote terminal 400 may remotely access and control the selected user equipment through the second port forwarding.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in the application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for enabling a remote terminal outside a private network to remotely access and control at least one user equipment inside the private network by a remote access control device in the private network, the method comprising:
requesting a gateway device of the private network to set up first port forwarding enabling the remote terminal to remotely access the remote access control device;
receiving a remote access request message from the remote terminal through the first port forwarding; and
requesting the gateway device to set up second port forwarding enabling the remote terminal to remotely access the at least one user equipment indicated in the received remote access request message in response to the remote access request message.

2. The method of claim 1, wherein the requesting a gateway device of the private network to set up first port forwarding includes:
requesting the gateway device to set up the first port forwarding based on a public IP address and a port number allocated to the gateway device and a first private IP address and a first port number allocated to the remote access control device.

3. The method of claim 2, wherein the gateway device sets up the first port forwarding to translate the public IP address and the port number allocated to the gateway device to the first private IP address and the first port number allocated to the remote access control device.

4. The method of claim 1, further comprising:
receiving a request for information regarding the at least one user equipment inside the private network from the remote terminal through the first port forwarding; and
providing the requested information to the remote terminal.

5. The method of claim 4, further comprising:
receiving simple service discovery protocol (SSDP) messages multicasted from the user equipments inside the private network;
obtaining information regarding the at least one user equipment based on the received SSDP messages; and
storing the obtained information in a memory,
wherein the remote access control device transmits the stored information to the remote terminal in response to the request for information.

6. The method of claim 4, including selecting, by the remote terminal, the at least one user equipment inside the private network to remotely access and control based on the provided information and creates the remote access request message based on the selected user equipment.

7. The method of claim 1, wherein the requesting the gateway device to set up second port forwarding includes:
requesting the gateway device to set up the second port forwarding based on a public IP address and a port number allocated to the gateway device and a second private IP address and a second port number allocated to the selected at least one user equipment.

8. The method of claim 7, wherein the gateway device sets up the second port forwarding by translating the public IP address and the port number allocated to the gateway device to the second private IP address and the second port number allocated to the selected at least one user equipment.

9. A remote access control device for enabling a remote terminal outside a private network to remotely access and control at least one user equipment inside the private network, the remote access control device comprising:
a receiver configured to receive a multicast message from each user equipment inside the private network, to receive a request for information regarding the at least one user equipments from the remote terminal, and to receive a remote access request message from the remote terminal;
a first port forwarding setup request unit configured to request a gateway device to set up first port forwarding in order to enable the remote terminal to remotely access the remote access control device;
a second port forwarding setup request unit configured to request the gateway device to set up second port forwarding in order to enable the remote terminal to remotely access and control selected user equipment inside the private network in response to the received remote access request message; and
a transmitter configured to transmit the information regarding the at least one user equipment to the remote terminal in response to the request for information.

10. The remote access control device of claim 9, wherein the first port forwarding setup request unit is configured to request the gateway device to set up the first port forwarding based on a public IP address and a port number allocated to the gateway device and a first private IP address and a first port number allocated to the remote access control device.

11. The remote access control device of claim 10, wherein the gateway device sets up the first port forwarding to translate the public IP address and the port number allocated to the gateway device to the first private IP address and the first port number allocated to the remote access control device.

12. The remote access control device of claim 9, wherein the receiver is configured to:
receive simple service discovery protocol (SSDP) messages multicasted from the at least one user equipment as the multicast message;
obtain the information on each user equipment based on the received SSDP messages; and
store the obtained information in a memory,
wherein the transmitter transmits the stored information to the remote terminal in response to the request for information.

13. The remote access control device of claim 9, wherein the remote terminal selects the at least one user equipment inside the private network to remotely access and control based on the provided information and creates the remote access request message based on the selected at least one user equipment.

14. The remote access control device of claim 9, wherein the second port forwarding setup request unit is configured to:
request the gateway device to set up the second port forwarding based on a public IP address and a port number allocated to the gateway device and a second private IP address and a second port number allocated to the selected user equipment.

15. The remote access control device of claim 14, wherein the gateway device sets up the second port forwarding to translate the public IP address and the port number allocated to the gateway device to the second private IP address and the second port number allocated to the selected user equipment.

16. A gateway device for enabling a remote terminal outside a private network to remotely access and control at least one user equipment inside the private network, the gateway device configured to:
set up first port forwarding to forward packets from the remote terminal to a remote access control device in response to a first port forwarding setup request from the remote access control device; and
set up second port forwarding to forward packets from the remote terminal to a selected user equipment in response to a second port forwarding setup request from the remote access control device.

17. The gateway device of claim 16, wherein the gateway device is configured to set up the first port forwarding to translate a public IP address and a port number allocated to the gateway device to a first private IP address and a first port number allocated to the remote access control device.

18. The gateway device of claim 16, wherein the gateway device is configured to set up the second port forwarding to translate a public IP address and a port number allocated to the gateway device to a second private IP address and a second port number allocated to a selected user equipment in the private network.

19. The gateway device of claim 16, wherein:
the remote access control device is configured to receive a request for information regarding the at least one user equipment inside the private network from the remote terminal through the first port forwarding and to provide the requested information to the remote terminal through the first port forwarding; and
the remote terminal is configured to receive the requested information through the first port forwarding, to select one of the at least one user equipment in the private network to remotely access and control based on the received information, and to transmit a remote access request message to the remote access control device through the first port forwarding.

20. The gateway device of claim 19, wherein the remote access control device is configured to receive the remote access request message from the remote terminal and to transmit the second port forwarding setup request to the gateway device to set up the second port forwarding in response to the remote access request message.
